(19) United States
(12) Patent Application Publication
(10) Pub. No.: US 2009/0224162 A1
(43) Pub. Date: Sep. 10, 2009

(54) IMAGING DEVICE AND PRODUCTION METHOD OF IMAGING DEVICE

(76) Inventors: Masafumi INUIYA, Ashigarakami-gun (JP); Shusuke MOGI, Tokyo (JP)

Correspondence Address: BIRCH STEWART KOLASCH & BIRCH, PO BOX 747, FALLS CHURCH, VA, 22040-0747, US

(21) Appl. No.: 12/397,945

(22) Filed: Mar. 4, 2009

(30) Foreign Application Priority Data
Mar. 5, 2008 (JP) P2008-055222

(51) Int. Cl. G01T 1/24

(52) U.S. Cl. 250/370.09

(57) ABSTRACT

An imaging device is provided and includes a plurality of pixel parts each including a photoelectric conversion layer that generates an electric charge according to an X-ray. The plurality of pixel parts includes: a substrate including a signal output unit that outputs a signal to an outside of the imaging device according to the electric charge generated in the photoelectric conversion layer; a lower electrode above the substrate; and an upper electrode above the lower electrode. The photoelectric conversion layer is disposed between the lower electrode and the upper electrode. The signal output unit includes a transistor of a single-crystal semiconductor. The lower electrode includes an electrically conductive material that absorbs at least an X-ray.

This application is based on and claims priority under 35 U.S.C. §119 from Japanese Patent Application No. 2008-055222 filed Mar. 5, 2008, the entire disclosure of which is herein incorporated by reference.

### BACKGROUND OF THE INVENTION

1. Field of the Invention

The present invention relates to an imaging device with a plurality of pixel parts each containing a photoelectric conversion layer that generates an electric charge according to an X-ray.

2. Description of Related Art

Conventionally, the readout process of an X-ray image sensor includes (1) a TFT direct readout process, (2) a TFT indirect readout process, and (3) a CCD or CMOS indirect readout process. FIG. 9 is a view schematically illustrating these three processes.

The TFT direct readout process is a process where an X-ray is received by a photoelectric conversion layer formed of a material capable of directly absorbing an X-ray and converting it into a signal charge, such as a-Se (amorphous selenium), and the signal charge generated is sequentially and selectively read out by a TFT (switch) panel.

The TFT indirect readout process is a process where an X-ray is converted into visible light by an X-ray scintillator, the visible light is received by a photoelectric conversion layer formed of a material capable of absorbing visible light and converting it into a signal charge, such as a-Si (amorphous silicon), and a signal charge generated in the photoelectric conversion layer based on the visible light is sequentially and selectively read out by a TFT panel.

The CCD or CMOS indirect readout process is a process where an X-ray is converted into visible light by an X-ray scintillator, the visible light is guided to a CCD-type or CMOS-type image sensor by a fiber plate, and a signal according to visible light is read out here by photoelectrically converting the visible light.

The photoelectric conversion layer formed of a polycrystalline material such as a-Se or a-Si, the X-ray scintillator, the a-Si-made TFT panel and the fiber plate are free from characteristic degradation or damages caused by the X-ray irradiation. However, in the photodiode part, CCD transfer part and MOS transistor part of the CCD-type or CMOS-type image sensor, which are formed of a single-crystal silicon, characteristic degradation such as change of threshold voltage Vth of the transistor or increase of dark current, and white damage/black damage (damages of crystal) are caused by the X-ray irradiation. Therefore, in the CCD or CMOS indirect readout process, a fiber plate formed of an X-ray absorbing glass such as lead glass is inserted between the X-ray scintillator and the CCD-type or CMOS-type image sensor to prevent the effect of X-ray on the CCD-type or CMOS-type image sensor.

As regards the CCD or CMOS indirect readout process, other than the use of a fiber plate, it is known to provide an X-ray shielding member as described in JP-A-2003-282849 and JP-A-2004-071638.

In the image sensors described in JP-A-2003-282849 and JP-A-2004-071638, a substrate having formed thereon a photoelectric conversion element and an electric charge transfer substrate having formed thereon a circuit for outputting a voltage signal according to a signal charge generated in the photoelectric conversion element are connected by an X-ray shielding member capable of absorbing an X-ray, and a silicon device region of the electric charge transfer substrate is covered by the X-ray shielding member, whereby the device is prevented from damages.

The TFT direct readout process or TFT indirect readout process using a TFT panel for the signal readout is advantageous in that X-ray shielding is not necessary. However, since the a-Si transistor used in the TFT panel is polycrystalline, the electron mobility is lower by several digits than the single-crystal Si. Also, fluctuation of characteristics (e.g., Vth) in the production is large and therefore, this readout process is not suitable particularly for high-definition imaging or motion imaging requiring high sensitivity, high S/N and high-speed readout.

On the other hand, the CCD-type or CMOS-type image sensor made of a single-crystal Si is suitable for high-definition or motion imaging, but a fiber plate made of lead glass or the like becomes necessary for shielding an X-ray. This fiber plate is expensive and heavy and is also difficult to produce as a large-area plate.

In the structures of JP-A-2003-282849 and JP-A-2004-071638, an X-ray shielding member needs to be provided between the substrate having formed thereon a photoelectric conversion element and the electric charge transfer substrate, and this is disadvantageous in that the entire image sensor becomes thick due to the X-ray shielding member and at the same time, the production cost rises.

### SUMMARY OF THE INVENTION

An object of an illustrative, non-limiting embodiment of the present invention is to provide an imaging device exhibiting high X-ray resistance and enabling high-definition imaging or motion imaging while realizing low cost and small size.

According to an aspect of the invention, there is provided an imaging device including a plurality of pixel parts each including a photoelectric conversion layer that generates an electric charge according to an X-ray. The plurality of pixel parts includes: a substrate including a signal output unit that outputs a signal to an outside of the imaging device according to the electric charge generated in the photoelectric conversion layer; a lower electrode above the substrate; and an upper electrode above the lower electrode. The photoelectric conversion layer is disposed between the lower electrode and the upper electrode. The signal output unit includes a transistor of a single-crystal semiconductor. The lower electrode includes an electrically conductive material that absorbs at least an X-ray.

In the imaging device, the transistor may be disposed so as to be covered by the lower electrode.

In the imaging device, the lower electrode may be separated into a plurality of lower electrodes corresponding to the respective pixel parts, and a light-shielding layer may be between a gap of adjacent lower electrodes and the substrate, the light-shielding layer including a material that absorbs at least an X-ray out of light transmitted through the gap.

In the imaging device, the material of the light-shielding layer absorbs also visible light.

In the imaging device, the pixel parts may include an electrode that is provided between the lower electrode and the photoelectric conversion layer and that includes an electrically conductive material having a work function different from that of the lower electrode.

In the imaging device, the electrically conductive material constituting the lower electrode may absorb also visible light.

In the imaging device, the electrically conductive material of the lower electrode may be a heavy metal having an atomic number of 73 or greater.

In the imaging device, the photoelectric conversion layer may absorb an X-ray and generate an electric charge according to the X-ray absorbed.

In the imaging device, the photoelectric conversion layer may include amorphous selenium.

In the imaging device, a scintillator for converting an X-ray into visible light may be provided above the upper electrode, and the photoelectric conversion layer may absorb visible light and generate an electric charge according to the visible light absorbed.

In the imaging device, the photoelectric conversion layer may include an organic material.

In the imaging device, the photoelectric conversion layer may include an inorganic material.

In the imaging device, the inorganic material may be amorphous silicon.

According to an aspect of the invention, there is provided a method for producing an imaging device that includes a plurality of pixel parts each including a photoelectric conversion layer that generates an electric charge according to an X-ray, the method including:

forming signal output units for the respective pixel parts in a substrate, wherein each of the signal output units includes a transistor of a single-crystal semiconductor and outputs a signal to an outside of the imaging device according to the electric charge generated in the photoelectric conversion layer;

forming a plurality of lower electrodes so as to be separated for the respective pixel parts through an insulating layer, wherein each of the lower electrodes includes an electrically conductive material that absorbs at least an X-ray;

forming the photoelectric conversion layer above the lower electrode; and

forming an upper electrode above the photoelectric conversion layer.

In the method for producing an imaging device, in the forming of the plurality of lower electrodes, the insulating layer may be formed by a material that absorbs visible light.

### BRIEF DESCRIPTION OF THE DRAWINGS

The features of the invention will appear more fully upon consideration of the exemplary embodiments of the inventions, which are schematically set forth in the drawings, in which:

FIG. 1 is a cross-sectional schematic view showing an imaging device according to a first exemplary embodiment of the present invention;

FIG. 2 is a cross-sectional schematic view showing an imaging device according to a second exemplary embodiment of the present invention;

FIG. 3 is a cross-sectional schematic view showing an imaging device according to a third exemplary embodiment of the present invention;

FIG. 4 is a cross-sectional schematic view showing one pixel part of an imaging device according to a fourth exemplary embodiment of the present invention;

FIG. 5 is an equivalent circuit diagram of the signal output part 6 shown in FIG. 4;

FIG. 6 is a cross-sectional schematic view showing each step in a production method of a solid-state imaging device shown in FIG. 4;

FIG. 7 is a cross-sectional schematic view showing one step in a production method of a solid-state imaging device shown in FIG. 4.

FIG. 8 is a cross-sectional schematic view showing one step in a production method of a solid-state imaging device shown in FIG. 4; and

FIG. 9 is a view for explaining readout processes of an X-ray image sensor.

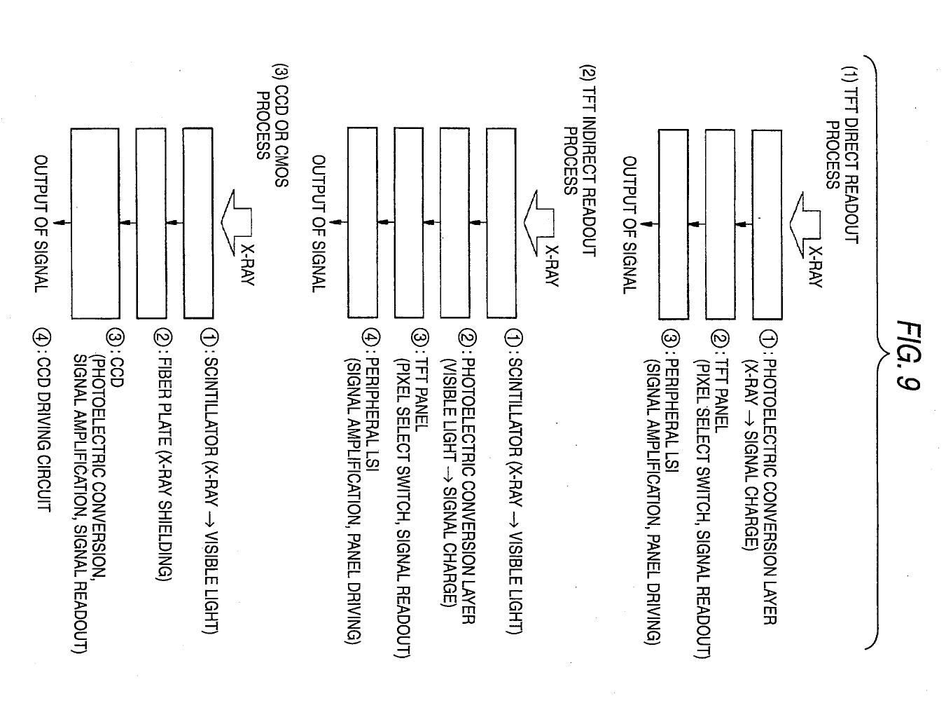

### DETAILED DESCRIPTION OF THE EXEMPLARY EMBODIMENTS

According to an exemplary embodiment of the present invention, an imaging device exhibiting high X-ray resistance and enabling high-definition imaging or motion imaging while realizing low cost and small size can be provided.

Exemplary embodiments of an imaging device of the present invention are described below by referring to the drawings. Imaging devices described in the following embodiments is used, for example, by mounting it in medical X-ray equipment.

### First Embodiment

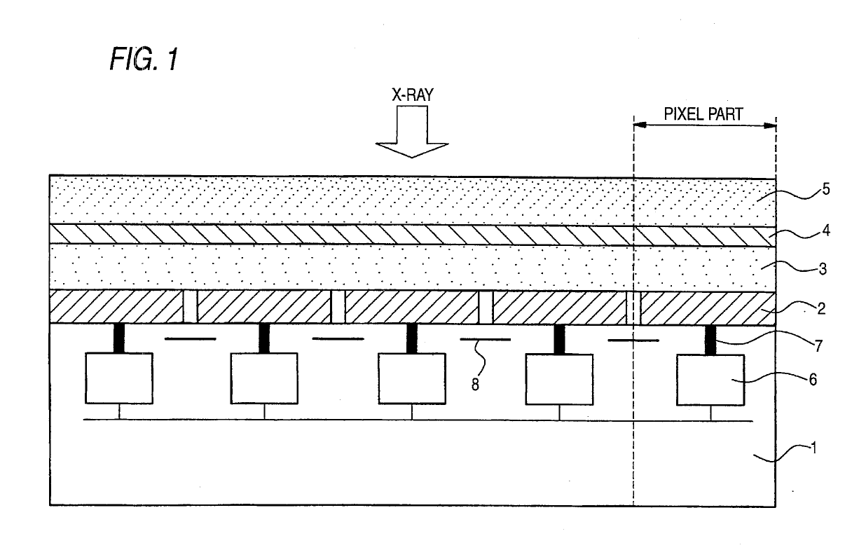

FIG. 1 is a cross-sectional schematic view showing an imaging device according to a first exemplary embodiment of the present invention.

The imaging device shown in FIG. 1 has a construction where a plurality of pixel parts are two-dimensionally arrayed and the image data can be produced based on signals output from respective pixel parts.

The imaging device shown in FIG. 1 includes: a signal output layer 1 including a substrate made of silicon as a single-crystal semiconductor and an insulating layer formed on the substrate; a lower electrode 2 formed on the signal output layer 1 and separated into a plurality of lower electrodes corresponding to the respective pixel parts; a monolithically constructed photoelectric conversion layer 3 formed on the lower electrode 2 and shared in common among the plurality of pixel parts, a monolithically constructed upper electrode 4 formed on the photoelectric conversion layer 3 and shared in common among the plurality of pixel parts, and an X-ray scintillator 5 formed on the upper electrode 4.

The X-ray scintillator 5 converts an X-ray incident from above into visible light and, for example, a GOS scintillator formed of GOS (Gd₂O₂S:Pr) may be used.

A photoelectric conversion element is constituted by a lower electrode 2 contained in a pixel part, a photoelectric conversion layer 3 and an upper electrode 4 which are overlapped with the lower electrode 2 when planarly viewed. In this photoelectric conversion element, when a bias voltage is applied between the lower electrode 2 and the upper electrode 4, a signal charge generated in the photoelectric conversion layer 3 is caused to move to the lower electrode 2 and the signal charge can be taken out therefrom into the signal output layer 1.

Visible light converted by the X-ray scintillator 5 comes incident from above on the upper electrode 4. The upper electrode 4 needs to allow the light (in this embodiment, visible light) incident thereon to enter into the photoelectric conversion layer 3 and therefore, is formed of an electrically conductive material transparent to incident light (for example, ITO). The upper electrode 4 is monolithically constructed and shared in common among all pixel parts but may be divided for each pixel part.

The photoelectric conversion layer 3 can generate a signal charge according to an X-ray when used in combination with an X-ray scintillator 5. The photoelectric conversion layer 3 is formed of an organic or inorganic photoelectric conversion material that absorbs visible light and generates a signal charge according to the quantity of light absorbed. Examples of the organic photoelectric conversion material include quinacridone. Use of quinacridone enables monochromatic imaging. Examples of the inorganic photoelectric conversion material include amorphous silicon. Incidentally, for enabling high-definition imaging and motion imaging, an organic photoelectric conversion material assured of high electron mobility and less production variation is preferably used as the material of the photoelectric conversion layer 3.

The photoelectric conversion layer 3 may also be made of a photoelectric conversion material that absorbs an X-ray and generates a signal charge according to the quantity of light absorbed (for example, amorphous selenium). In the case of using such a material, the material alone can generate a signal charge according to an X-ray even when not combined with an X-ray scintillator 5 and therefore, the X-ray scintillator 5 becomes unnecessary. In this case, the upper electrode 4 needs to be made of an electrically conductive material capable of transmitting an X-ray (for example, aluminum or ITO).

Inside of the signal output layer 1, a signal output part 6 is provided to correspond to each photoelectric conversion element. In the signal output part 6, a signal charge generated in the photoelectric conversion layer 3 of the corresponding photoelectric conversion element and caused to move to the lower electrode 2 is converted into a voltage signal according to the quantity of signal charge and output to the outside, and, for example, a known CMOS circuit is used. Hereinafter, the signal output part 6 is sometimes referred to as a CMOS circuit 6.

The CMOS circuit 6 contains an MOS transistor as a constituent element made of single-crystal silicone that is damaged by an X-ray. Accordingly, the MOS transistor contained in the CMOS circuit 6 is disposed to be completely covered by the lower electrode 2 of the corresponding photoelectric conversion element.

Furthermore, inside of the signal output layer 1, a contact wiring 7 formed of an electrically conductive material is provided. The contact wiring 7 fulfills a role of electrically connecting the lower electrode 2 to the CMOS circuit 6 and causing a signal charge collected in the lower electrode 2 to move into the CMOS circuit 6.

The lower electrode 2 is made of an electrically conductive material that absorbs visible light and an X-ray. Such a material includes a heavy metal having an atomic number of 73 or greater, such as tantalum, tungsten, gold and lead. Incidentally, the lower electrode 2 is sufficient if it absorbs at least an X-ray, and visible light may be transmitted therethrough.

The MOS transistor contained in the CMOS circuit 6 is formed using silicon and therefore, the MOS transistor should be usually light-shielded by a light-shielding layer such as tungsten. In this embodiment, since the MOS transistor of the CMOS circuit 6 is completely covered by the lower electrode 2 or the lower electrode 2 absorbs visible light and an X-ray, the light-shielding layer is not necessary. However, in the case where an electrically conductive material that transmits visible light is used for the lower electrode 2, a light-shielding layer such as tungsten needs to be separately provided in the signal output layer 1 for preventing visible light from entering into the MOS transistor of the CMOS circuit 6.

In the signal output layer 1 beneath the gap between adjacent lower electrodes 2, a light-shielding layer 8 is provided so as to prevent visible light transmitted through the gap from intruding deeply into the signal output layer 1 and becoming stray light.

The operation of the solid-state imaging device having the above-described construction is described below.

When an X-ray comes incident, the X-ray is converted into visible light by an X-ray scintillator 5. However, the X-ray scintillator 5 is limited in its thickness and fails in sufficiently absorbing the X-ray, as a result, several % of the incident X-ray passes through the X-ray scintillator 5.

Visible light converted by the X-ray scintillator 5 passes through the upper electrode 4, enters into the photoelectric conversion layer 3 and is there converted into a signal charge. However, the visible light is not converted into a signal charge in its entirety, and a part of the visible light entered into the photoelectric conversion layer 3 passes through the photoelectric conversion layer 3. Also, the X-ray passed through the X-ray scintillator 5 enters into the photoelectric conversion layer 3 and passes through the layer.

A part of the visible light and X-ray passed through the photoelectric conversion layer 3 enter into the lower electrode 2 and are absorbed there, and the remaining passes through the gap between lower electrodes 2 and enters into the light-shielding layer 8, where the visible light is reflected and absorbed and the X-ray is caused to pass through the light-shielding layer 8, penetrate the signal output layer 1 and go outside.

After the completion of exposure, the signal charge generated in the photoelectric conversion layer 3 is converted into a voltage signal by the CMOS circuit 6, the voltage signal is sequentially output from each pixel, and signal processing is applied to the voltage signal output, whereby, for example, the interior image of a human body can be obtained as monochromatic image data.

Also, the operation of the solid-state imaging device where the X-ray scintillator 5 is omitted and the photoelectric conversion layer 3 is made of a photoelectric conversion material that absorbs an X-ray, is described below.

When an X-ray is incident, the X-ray passes through the upper electrode 4, enters into the photoelectric conversion layer 3 and is there converted into a signal charge. However, the X-ray is not converted into a signal charge in its entirety, and a part of the X-ray entered into the photoelectric conversion layer 3 passes through the photoelectric conversion layer 3. Since the incident light contains also visible light, this visible light similarly enters into the photoelectric conversion layer 3 and passes through the layer.

A part of the visible light and X-ray passed through the photoelectric conversion layer 3 enter into the lower electrode 2 and are absorbed there, and the remaining passes through the gap between lower electrodes 2 and enters into the light-shielding layer 8, where the visible light is reflected and absorbed and the X-ray is caused to pass through the light-shielding layer 8, penetrate the signal output layer 1 and go outside.

After the completion of exposure, the signal charge generated in the photoelectric conversion layer 3 is converted into a voltage signal by the CMOS circuit 6, the voltage signal is sequentially output from each pixel, and signal processing is applied to the voltage signal output, whereby, for example, the interior image of a human body can be obtained as monochromatic image data.

In this way, according to the solid-state imaging device of this embodiment, the X-ray passed through the photoelectric conversion layer 3 is absorbed in the lower electrode 2 and an X-ray is not allowed to enter into the MOS transistor of the CMOS circuit 6, so that the MOS transistor can be protected from X-ray damage and enhanced in the X-ray resistance. Also, since the lower electrode 2 absorbs also the visible light, the lower electrode 2 itself can function as the light-shielding layer for the CMOS circuit 6 and a light-shielding layer need not be provided separately, which enables reduction in the thickness of the signal output layer 1 and cost reduction.

Furthermore, according to the solid-state imaging device of this embodiment, the lower electrode 2 as a constituent element of the photoelectric conversion element is designed to serve also as a protective member for the MOS transistor of the CMOS circuit 6 and therefore, unlike conventional techniques, an X-ray shielding member need not be provided separately. In addition, when tantalum, tungsten, lead or the like is used as the material of the lower electrode 2, these materials all can absorb 90% or more of the incident X-ray with a thickness of 50 to 100 μm. Since from 80 to 90% of the incident X-ray is absorbed by the X-ray scintillator 5, the effect on the MOS transistor of the CMOS circuit 6 can be sufficiently blocked only by forming the lower electrode 2 to a thickness of approximately from 50 to 100 μm. That is, the CMOS circuit 6 can be prevented from damage only by forming the lower electrode 2 to a thickness of approximately from 50 to 100 μm, instead of separately providing a conventional X-ray-shielding member, so that downsizing and cost reduction of the solid-state imaging device can be realized.

Incidentally, the pixel size (corresponding to the size of the lower electrode 2) of an X-ray image sensor is generally from 100 to 150 μm and therefore, it is not particularly difficult in view of production to form the lower electrode 2 to a thickness of 50 to 100 μm.

In this way, in the solid-state imaging device of this embodiment, a signal is output by employing a CMOS circuit using single-crystal silicon and therefore, the imaging device is excellent in the sensitivity, S/N and high-speed readout as compared with an X-ray image sensor using an amorphous silicon TFT. Furthermore, a fiber plate is not necessary and therefore, low cost and lightweighting can be realized as compared with an X-ray image sensor using a fiber plate and a CMOS image sensor in combination.

### Second Embodiment

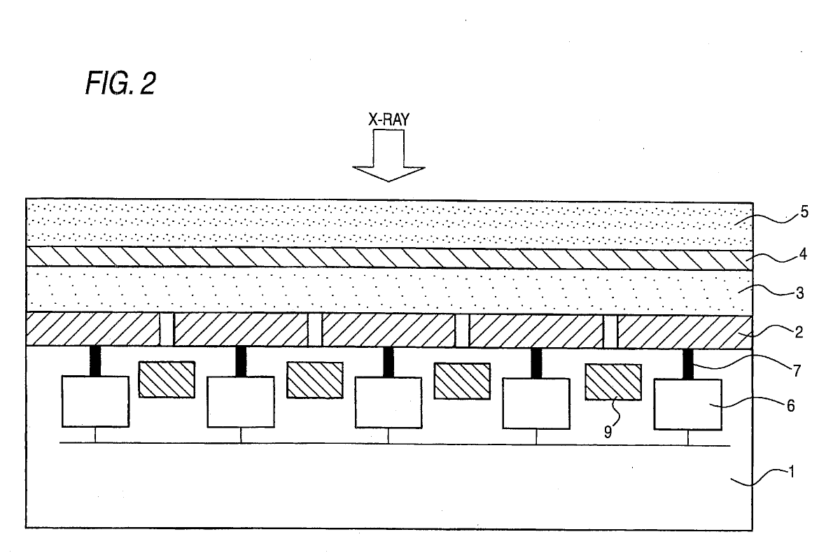

FIG. 2 is a cross-sectional schematic view showing an imaging device according to a second exemplary embodiment of the present invention. In FIG. 2, the same numerals are used for the same constituents as in FIG. 1.

The solid-state imaging device shown in FIG. 2 has a construction where the light-shielding layer 8 of the solid-state imaging device shown in FIG. 1 is changed to a light-shielding layer 9.

The light-shielding layer 9 is made of a material that absorbs visible light and an X-ray. As regards the material, the same materials as for the lower electrode 2 can be used.

The operation of the solid-state imaging device shown in FIG. 2 differs from that of the solid-state imaging device shown in FIG. 1 only in that both the X-ray and visible light passed through the gap between lower electrodes 2 are absorbed in the light-shielding layer 9 and are not transmitted and reflected to other portions.

According to the solid-state imaging device of the second embodiment, the X-ray passed through the gap between lower electrodes 2 can also be absorbed by the light-shielding layer 9, so that the probability of the X-ray entering into the CMOS circuit 6 can be made lower than in the first embodiment and the X-ray resistance of the solid-state imaging device can be more enhanced.

Incidentally, according to the solid-state imaging device of the second embodiment, even when the MOS transistor of the CMOS circuit 6 is not perfectly covered by the lower electrode 2, the X-ray can be almost completely cut by the lower electrode 2 and the light-shielding layer 9. Therefore, the MOS transistor of the CMOS circuit 6 need not be disposed to be perfectly covered by the lower electrode 2, and the design latitude of the CMOS circuit 6 can be enhanced.

Furthermore, since the light-shielding layer 9 absorbs also visible light, the light-shielding layer 8 of FIG. 1 can be concurrently served by the light-shielding layer 9 and an extra space becomes unnecessary. In addition, the light-shielding layer 9 is lighter in weight and smaller in area than the fiber plate and therefore, is not contrary to the reduction in size, weight and cost.

Incidentally, the light-shielding layer 9 may be composed of a material that does not absorb visible light. In this case, a light-shielding layer may be separately provided so as to prevent visible light passed through the light-shielding layer 9 from entering into the CMOS circuit 6. Even if a light-shielding layer is separately provided, this light-shielding layer is lighter in weight and smaller in area than the fiber plate and therefore, is not contrary to the reduction in size, weight and cost.

### Third Embodiment

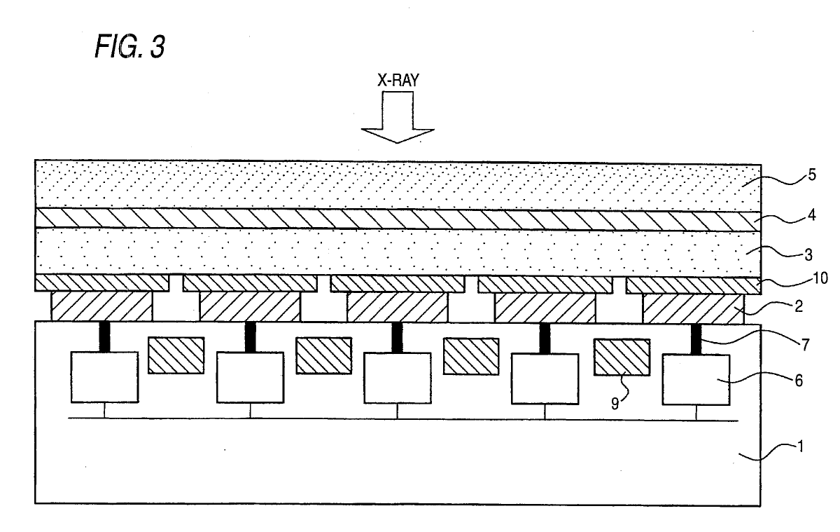

FIG. 3 is a cross-sectional schematic view showing an imaging device according to a third exemplary embodiment of the present invention. In FIG. 3, the same numerals are used for the same constituents as in FIG. 2.

The solid-state imaging device shown in FIG. 3 has a construction where an electrode 10 is added between the lower electrode 2 and the photoelectric conversion layer 3 of the solid-state imaging device shown in FIG. 2.

The electrode 10 is provided for allowing an electron or a hole to transfer on the interface between the lower electrode 2 and the photoelectric conversion layer 3 without a potential barrier and is made of an electrically conductive material differing in the work function from the lower electrode 2. By differentiating the work function of the lower electrode 2 from the work function of the electrode 10, the potential barrier becomes lower when an electron or a hole transfers from the photoelectric conversion layer 3 to the lower electrode 2, as a result, the extraction efficiency of a signal electrode from the photoelectric conversion layer 3 can be raised.

The operation of the solid-state imaging device shown in FIG. 3 differs from that of the solid-state imaging device shown in FIG. 2 only in that the X-ray and visible light passed through the photoelectric conversion layer 3 enter into the lower electrode 2 after passing through the electrode 10.

According to the solid-state imaging device of the third embodiment, an electrode 10 differing in the work function from the lower electrode 2 is provided between the lower electrode 2 and the photoelectric conversion layer 3, so that the extraction efficiency of a signal charge from the photoelectric conversion layer 3 can be raised and the sensitivity can be enhanced. Incidentally, the area of the electrode 10 and the area of the lower electrode 2 may be the same or different.

### Fourth Embodiment

In the fourth embodiment, a construction of the pixel part of the solid-state imaging device shown in FIG. 3 is described in greater detail.

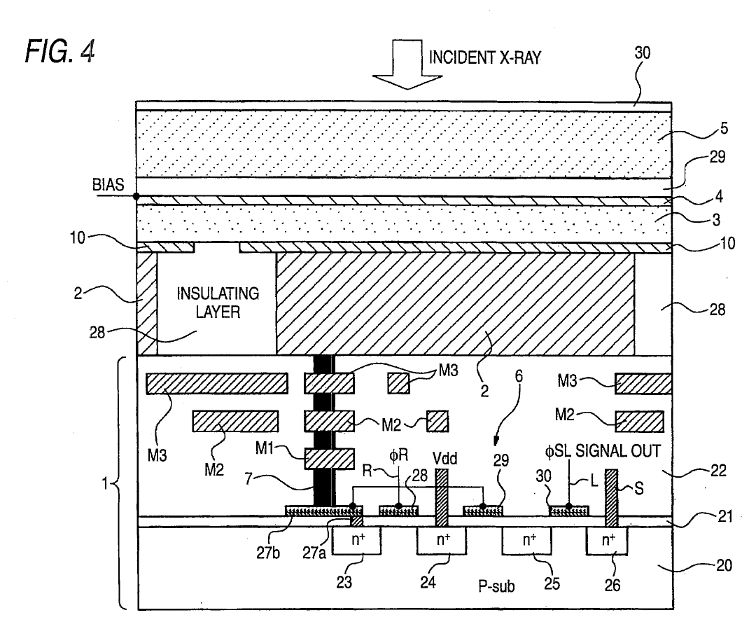

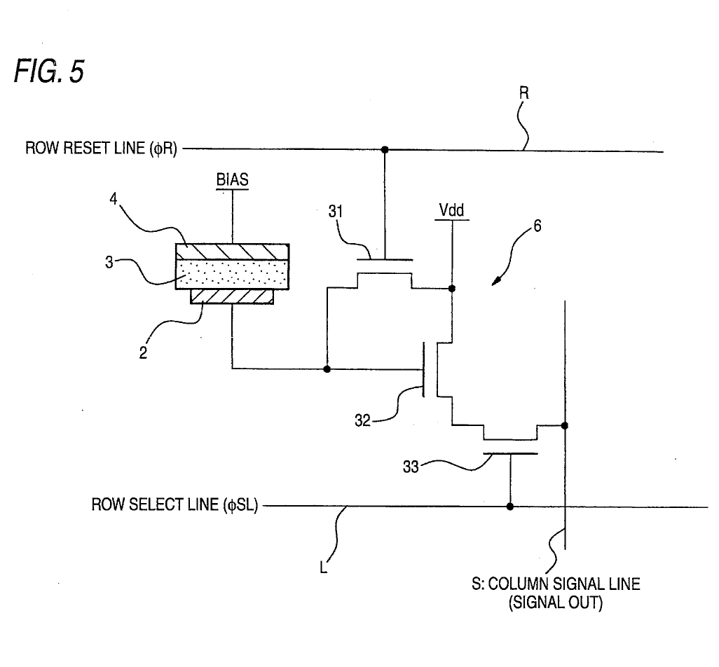

FIG. 4 is a cross-sectional schematic view showing one pixel part of an imaging device in the fourth embodiment of the present invention. In FIG. 4, the same numerals are used for the same constituents as in FIG. 3. FIG. 5 is an equivalent circuit diagram of CMOS 6 shown in FIG. 4.

A signal output layer 1 includes a p-type silicon substrate 20, a gate insulating layer 21 formed on the substrate, and an insulating film 22 formed thereon.

In the p-type silicon substrate 20, n-type impurity regions (hereinafter referred to as an “n-region”) 23 to 26 working out to a source region or a drain region of an MOS transistor constituting a CMOS circuit 6 are formed.

The n-region 24 is connected to a power source Vdd and the n-region 26 is connected to a column signal line S. An electrode 27b is formed on the n-region 23 through the gate insulating layer 21, and a contact wiring 7 is connected to the electrode 27b. The electrode 27b and the n-region 23 are electrically connected by an wiring 27a buried in the gate insulating layer 21, whereby signal charges collected by a lower electrode 2 pass through the contact wiring 7, electrode 27b and wiring 27a and are accumulated in the n-region 23.

As shown in FIG. 5, the CMOS circuit 6 comprises a reset transistor 31 that is an MOS transistor for resetting the signal charges accumulated in the n-region 23, an output transistor 32 that is an MOS transistor for converting the signal charges accumulated in the n-region 23 into voltage signals and outputting the voltage signals, a row select transistor 33 that is an MOS transistor for selectively outputting the voltage signals output from the output transistor 32 into the column signal line S, and lines (reset line R, row select line L, column signal line S) for driving those transistors.

Out of the CMOS circuit 6, the reset line R, row select line L and column signal line S are generally formed of aluminum and not affected by an X-ray, but the reset transistor 31, output transistor 32 and row select transistor 33 are formed of single-crystal silicone and therefore, damaged by an X-ray. Accordingly, out of the CMOS circuit 6, at least the reset transistor 31, output transistor 32 and row select transistor 33 are disposed below the lower electrode 2 so as to be completely covered by the lower electrode 2.

A reset line R is connected to the gate of the reset transistor 31, and a row select line L is connected to the gate of the row select transistor 33.

When a row select signal is fed to the row select line L from a scanning circuit not shown, a voltage signal output from the output transistor 32 is output into the column signal line S. Also, when a reset signal φR is fed to the reset signal line R, signal charges in the n-region 23 are reset by the reset signal φR.

Backing to FIG. 4, a gate electrode 28 of the reset transistor 31 is formed above and in between the n-region 23 and the n-region 24 through the gate insulating layer 21, a gate electrode 29 of the output transistor 33 is formed above and in between the n-region 24 and the n-region 25 through the gate insulating layer 21, and a gate electrode 30 of the row select transistor 33 is formed above and in between the n-region 25 and the n-region 26 through the gate insulating layer 21.

Inside of an insulating layer 22 of the signal output layer 1, a three-layer wiring (M1, M2 and M3) generally employed in a CMOS-type image sensor is further formed. The third layer wiring M3 is formed below the gap between lower electrodes 2 to completely fill the gap when planarly viewed. The wiring M3 is formed of an electrically conductive material that absorbs visible light and an X-ray, and this wiring M3 located below the gap functions as the light-shielding 9 of FIG. 3.

A lower electrode 2 is formed on the insulating layer 22 to be separated for each pixel part through a transparent insulating layer 28 such as silicon oxide; an electrode 10 separated for each pixel is formed on the lower electrode 2; and a photoelectric conversion layer 3 is formed on the electrode 10.

An upper electrode 4 is formed on the photoelectric conversion layer 3, an X-ray scintillator 5 is formed on the upper electrode 4 through a protective layer 29 for protecting the photoelectric conversion element, and a reflection layer 30 made of aluminum is formed on the X-ray scintillator 5.

According to the solid-state imaging device having such a construction, an X-ray passed through the photoelectric conversion layer 3 can be prevented from entering into the reset transistor 31, output transistor 32 and row select transistor 33 of the CMOS circuit 6, so that characteristic deterioration of the CMOS circuit 6 can be prevented and reliability of the device can be enhanced.

Also, out of the three-layer wiring generally employed in a CMOS circuit, the wiring M3 can be made to function as the light-shielding layer 9 shown in FIG. 3. That is, a light-shielding layer 9 need not be separately provided and therefore, reduction in the cost and size can be realized.

Furthermore, according to the solid-state imaging device of this embodiment, out of the visible light after conversion by the X-ray scintillator 5, visible light exiting to the direction from which the X-ray is incident can be reflected by the reflection layer 30, so that this visible light can be effectively utilized and the light utilization efficiency can be raised.

Incidentally, the wiring M3 may be formed of a material that transmits visible light. In this case, the insulating layer 28 filling the gap between lower electrodes 2 is formed of an insulating material opaque to visible light (for example, a resist material having dispersed therein a black dye or pigment, which is used for a black matrix of a color filter of a liquid crystal panel), whereby visible light can be prevented from entering into the CMOS circuit 6.

A production method of the solid-state imaging device shown in FIG. 4 is described below.

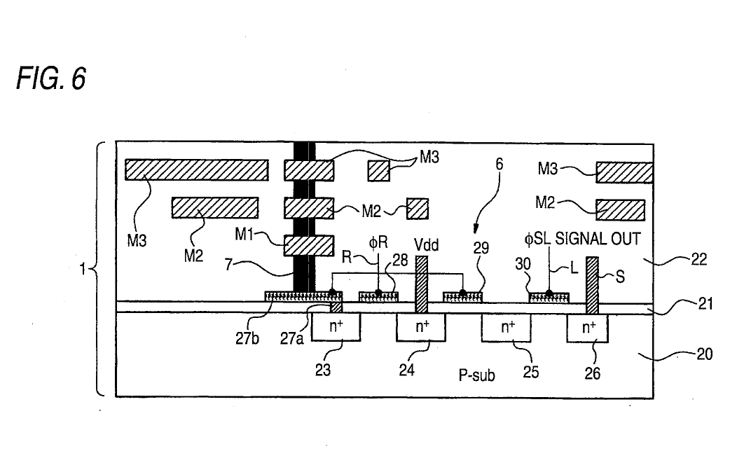

FIGS. 6 to 8 are cross-sectional schematic views showing respective steps in a production method of the solid-state imaging device shown in FIG. 4.

First, as shown in FIG. 6, constituent elements inside of a signal output layer 1 are formed by a known CMOS process. At this time, in the region where a lower electrode 2 should be formed when planarly viewed, MOS transistors of a CMOS circuit 6 are disposed. Also, a wiring M3 is disposed to fill the gap between lower electrodes 2 when planarly viewed.

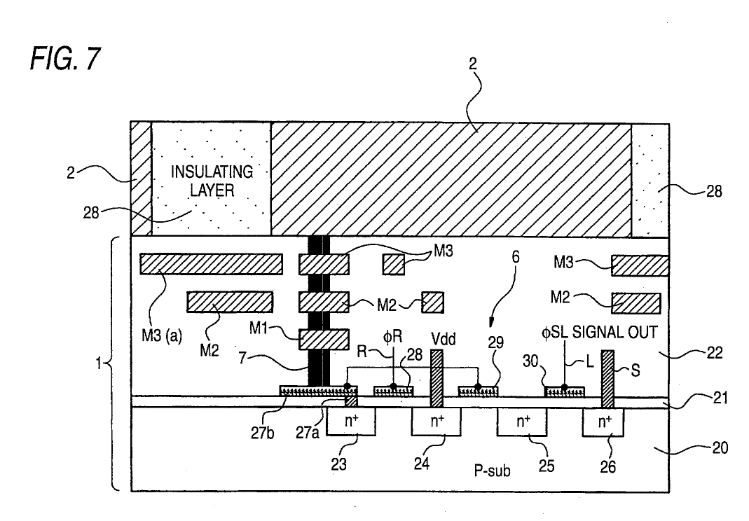

Next, as shown in FIG. 7, a lower electrode 2 separated for each pixel part through an insulating film 28 is formed on an insulting film 22.

For example, a heavy metal such as WNx (a noncrystalline material obtained by mixing about 5% of nitrogen with tungsten) or Ta (tantalum) is formed into a layer on the insulating layer 22 by sputtering, and the obtained layer is patterned by photolithography to form the lower electrode 2. Then, an insulating material is formed into a layer thereon, this layer is planarized by CMP, and an insulating material is filled in the gap between lower electrodes 2 to form an insulating layer 28. The insulating material filled in the gap between lower electrodes 2 is preferably the above-described material that absorbs visible light.

Alternatively, an insulating material is formed into a layer on the insulating layer 22, and the obtained layer is patterned by photolithography to form an insulating layer 28. Then, the material for a lower electrode 2 is formed into a layer thereon, and this layer is planarized by CMP to fill the heavy metal in the gap between insulating layers 28 and form a lower electrode 2. The insulating layer 28 is preferably formed of the above-described material that absorbs visible light.

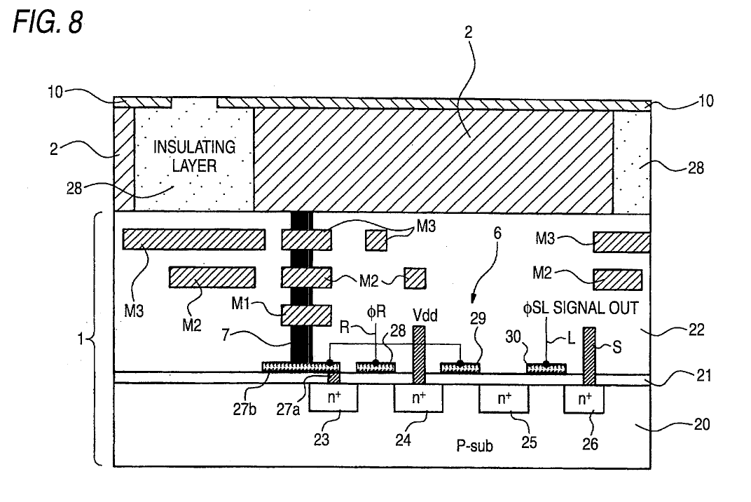

Subsequently, aluminum is formed into a layer by vapor deposition on the insulating layer 28 and the lower electrode 2, and the obtained layer is patterned by photolithography to form an electrode 10. Then, an insulating material is film-formed thereon, and this layer is planarized by CMP to fill the insulating material in the gap between electrodes 10, whereby the state shown in FIG. 8 is fabricated.

Thereafter, a photoelectric conversion layer 3, an upper electrode 4 and a protective layer 29 are formed in order. The photoelectric conversion layer 3 may be formed to have a structure where an electron blocking layer, a photoelectric conversion material layer and a hole blocking layer are stacked and formed on the lower electrode 2.

Furthermore, GOS is coated on the protective 29 to form an X-ray scintillator 5, and aluminum is vapor-deposited thereon to form a reflection layer 30, thereby completing the device.

As described above, in the solid-state imaging device of this embodiment, unlike a method of separately producing a signal output layer 1 and a photoelectric conversion element and stacking these to complete a device, the device is completed by forming a photoelectric conversion element on a signal output layer 1, so that the production can be facilitated as compared with the conventional technique where lamination accuracy is required.

What is claimed is:

1. An imaging device comprising a plurality of pixel parts each including a photoelectric conversion layer that generates an electric charge according to an X-ray,
wherein
the plurality of pixel parts includes: a substrate including a signal output unit that outputs a signal to an outside of the imaging device according to the electric charge generated in the photoelectric conversion layer; a lower electrode above the substrate; and an upper electrode above the lower electrode,
the photoelectric conversion layer is disposed between the lower electrode and the upper electrode,
the signal output unit includes a transistor of a single-crystal semiconductor, and
the lower electrode includes an electrically conductive material that absorbs at least an X-ray.

2. The imaging device according to claim 1, wherein the transistor is disposed so as to be covered by the lower electrode.

3. The imaging device according to claim 1, wherein the lower electrode is separated into a plurality of lower electrodes corresponding to the respective pixel parts, and
the imaging device further comprises a light-shielding layer between a gap of adjacent lower electrodes and the substrate, the light-shielding layer including a material that absorbs at least an X-ray out of light transmitted through the gap.

4. The imaging device according to claim 3, wherein the material of the light-shielding material absorbs visible light.

5. The imaging device according to claim 1, wherein the pixel parts include an electrode that is provided between the lower electrode and the photoelectric conversion layer and that includes an electrically conductive material having a work function different from that of the lower electrode.

6. The imaging device according to claim 1, wherein the electrically conductive material of the lower electrode absorbs visible light.

7. The imaging device according to claim 1, wherein the electrically conductive material of the lower electrode is a heavy metal having an atomic number of 73 or greater.

8. The imaging device according to claim 1, wherein the photoelectric conversion layer absorbs an X-ray and generates an electric charge according to the X-ray absorbed.

9. The imaging device according to claim 8, wherein the photoelectric conversion layer includes amorphous selenium.

10. The imaging device according to claim 1, further comprising a scintillator above the upper electrode, the scintillator converting an X-ray into visible light,
wherein the photoelectric conversion layer absorbs visible light and generates an electric charge according to the visible light absorbed.

11. The imaging device according to claim 10, wherein the photoelectric conversion layer includes an organic material.

12. The imaging device according to claim 10, wherein the photoelectric conversion layer includes an inorganic material.

13. The imaging device according to claim 12, wherein the inorganic material is amorphous silicon.

14. A method for producing an imaging device that includes a plurality of pixel parts each including a photoelectric conversion layer that generates an electric charge according to an X-ray, the method comprising:
forming signal output units for the respective pixel parts in a substrate, wherein each of the signal output units includes a transistor of a single-crystal semiconductor and outputs a signal to an outside of the imaging device according to the electric charge generated in the photoelectric conversion layer;
forming a plurality of lower electrodes so as to be separated for the respective pixel parts through an insulating layer, wherein each of the lower electrodes includes an electrically conductive material that absorbs at least an X-ray;
forming the photoelectric conversion layer above the lower electrode; and
forming an upper electrode above the photoelectric conversion layer.

15. The method according to claim 14, wherein in the forming of the plurality of lower electrodes, the insulating layer is formed by a material that absorbs visible light.
